(19) United States
(12) Patent Application Publication
(10) Pub. No.: US 2023/0300883 A1
(43) Pub. Date: Sep. 21, 2023

(54) ADVANCED PREEMPTION TECHNIQUES FOR IMPROVED NETWORK PERFORMANCE IN WIRELESS COMMUNICATIONS

(71) Applicants: Juan FANG, Portland, OR (US); Dmitry AKHMETOV, Hillsboro, OR (US); Daniel BRAVO, Portland, OR (US); Laurent CARIOU, Milizac (FR); Dibakar DAS, Hillsboro, OR (US); Thomas J. KENNEY, Portland, OR (US); Qinghua LI, San Ramon, CA (US); Minyoung PARK, San Ramon, CA (US); Robert STACEY, Portland, OR (US)

(72) Inventors: Juan FANG, Portland, OR (US); Dmitry AKHMETOV, Hillsboro, OR (US); Daniel BRAVO, Portland, OR (US); Laurent CARIOU, Milizac (FR); Dibakar DAS, Hillsboro, OR (US); Thomas J. KENNEY, Portland, OR (US); Qinghua LI, San Ramon, CA (US); Minyoung PARK, San Ramon, CA (US); Robert STACEY, Portland, OR (US)

(21) Appl. No.: 18/324,041

(22) Filed: May 25, 2023

Related U.S. Application Data
(60) Provisional application No. 63/429,943, filed on Dec. 2, 2022.

(51) Int. Cl. H04W 74/08

(52) U.S. Cl. CPC H04W 74/0808

(57) ABSTRACT

This disclosure describes systems, methods, and devices related to enhanced aggregate preemption. A device may divide a transmit opportunity (TXOP) transmission into physical layer convergence procedure service data unit (PSDU) or physical layer (PHY) convergence protocol data unit (PPDU) transmissions. The device may establish fixed time intervals between two continuous PSDU or PPDU transmissions. The device may sense an idle status of a channel after an end of each PSDU or PPDU transmission. The device may send a first suspend request (SR) control frame after an end of receiving a current PSDU or PPDU transmission.

### CROSS-REFERENCE TO RELATED APPLICATION(S)

This application claims the benefit of U.S. Provisional Application No. 63/429,943, filed Dec. 2, 2022, the disclosure of which is incorporated herein by reference as if set forth in full.

### TECHNICAL FIELD

This disclosure generally relates to systems and methods for wireless communications and, more particularly, to advanced preemption techniques for improved network performance and wireless communications.

### BACKGROUND

The rapid growth of Wi-Fi devices within a basic service set (BSS) and the increasing demand for high throughput, high reliability, and low latency communication have highlighted the limitations of existing Wi-Fi standards.

### BRIEF DESCRIPTION OF THE DRAWINGS

FIG. 1 is a network diagram illustrating an example network environment for enhanced aggregate preemption, in accordance with one or more example embodiments of the present disclosure.

FIGS. 2A-2C depict illustrative schematic diagrams for enhanced aggregate preemption, in accordance with one or more example embodiments of the present disclosure.

FIGS. 3A-3B, 4A-4B, 5A-5B, and 6A-6B depict illustrative schematic diagrams for enhanced aggregate preemption, in accordance with one or more example embodiments of the present disclosure.

FIG. 7 illustrates a flow diagram of a process for an illustrative enhanced aggregate preemption system, in accordance with one or more example embodiments of the present disclosure.

FIG. 8 illustrates a functional diagram of an exemplary communication station that may be suitable for use as a user device, in accordance with one or more example embodiments of the present disclosure.

FIG. 9 illustrates a block diagram of an example machine upon which any of one or more techniques (e.g., methods) may be performed, in accordance with one or more example embodiments of the present disclosure.

FIG. 10 is a block diagram of a radio architecture in accordance with some examples.

FIG. 11 illustrates an example front-end module circuitry for use in the radio architecture of FIG. 10, in accordance with one or more example embodiments of the present disclosure.

FIG. 12 illustrates an example radio IC circuitry for use in the radio architecture of FIG. 10, in accordance with one or more example embodiments of the present disclosure.

FIG. 13 illustrates an example baseband processing circuitry for use in the radio architecture of FIG. 10, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The concept of Aggregate Physical Layer Convergence Procedure Service Data Unit (A-PSDU) was introduced alongside Aggregate Medium Access Control (MAC) Protocol Data Unit (MPDU) and Aggregate MAC Service Data Unit (MSDU) during the development of the 802.11n standard. The aggregation was not standardized in the 802.11n standard because at that time the number of users within each Basic Service Set (BSS) was small, and AMPDU or AMSDU was sufficient to support high throughput. However, currently, the number of Wi-Fi devices within each BSS is increasing dramatically. On the other hand, high throughput is not the only Key Performance Indicator (KPI) required by users. In addition to high throughput, high reliability and low latency are two important KPIs required by today's users. This disclosure aims to address these needs.

In the context of IEEE 802.11 Wi-Fi standards, both PPDU and PSDU are considered types of frames. A frame refers to a packet of data transmitted across a network. In networking protocols, including Wi-Fi, this data transmission occurs in segments, often called frames or packets. The PPDU represents the entire frame that undergoes transmission across the physical medium. It encompasses the actual data (PSDU) and other elements necessary for communication, such as preambles, headers, and error checking bits. On the other hand, the PSDU is essentially the “payload” or actual data content of the frame. It gets encapsulated within the PPDU for transmission. Hence, while both are types of frames, the PPDU is the comprehensive package transmitted, whereas the PSDU is the actual data content encapsulated within this package.

To boost the overall throughput of Wi-Fi devices, Transmit Opportunity (TXOP) and frame aggregation (Aggregate Medium Access Control Protocol Data Unit (AMPDU) or Aggregate MAC Service Data Unit (AMSDU)) were introduced in the 802.11n standard and subsequent standards. This aggregation results in a much larger Physical Layer Convergence Procedure Protocol Data Unit (PPDU) data payload, which in turn occupies a much longer airtime to achieve high throughput.

While frame aggregation (AMPDU/AMSDU) contributes to improved throughput and reduced average latency for a pair of stations (STAs), it can lead to much higher worst-case latency for a third-party STA waiting for the wireless medium to be idle. This is due to the longer airtime occupied by a long aggregated PPDU between the pair of STAs. Time-sensitive frames may experience increased latency if the channel is occupied by a long PPDU transmission.

The “green-field operation in multi-link” loads high throughput applications and time-critical applications over different operational channels or restricts certain channels for time-critical applications only. However, providing good service to clients with both very small time-critical (TC) packets requiring ultra-low latency (ULL) and larger frames that also require high throughput, remains a challenge.

In the downlink, with A-MPDU preemption, the Access Point (AP) can suspend the next MPDU transmission to a STA in order to insert a time-critical packet transmission to the ultra-low latency (ULL) STA at the MPDU level. This idea can be applied to both Single User Orthogonal Frequency Division Multiplexing (SU OFDM) PPDU and Multi User Orthogonal Frequency Division Multiple Access (MU OFDMA) PPDU. It can also be extended to peer-to-peer scenarios. A STA inserts a packet for another STA while sending packets to the AP. However, the same physical layer parameters, such as Modulation and Coding Scheme (MCS), must be used for both the original STA and the ULL STA. Beamforming cannot be used.

Reserving a dedicated Resource Unit (RU) for time-sensitive traffic transmission facilitates the downlink TC packet transmission over a dedicated RU with DL MU OFDMA, while the other RUs are occupied by the downlink transmission within the Basic Service Set (BSS). It also enables the uplink TC packet transmission over null tones or a dedicated RU while the channel is occupied by the uplink transmission within the BSS. This requires the transmitter of the TC packet to synchronize with the AP based on the trigger frame. However, it does not support downlink TC packet transmission while the channel is occupied by the uplink transmission, or uplink TC packet transmission while the channel is occupied by the downlink transmission.

Dividing the long TXOP transmission into several mini PPDU transmissions and using the blank Short Interframe Space (SIFS) time for the AP or STA with time-sensitive packets to be transmitted allows sending a resource request or suspend request frame. However, it incurs a significant spectrum efficiency loss due to the legacy preamble at the beginning of each PPDU transmission.

In this disclosure, integrating the above concepts with A-PSDU supports ULL applications for small TC packets while maintaining high throughput for large packet transmission.

Example embodiments of the present disclosure relate to systems, methods, and devices for enhanced aggregate preemption.

This disclosure aims to address the challenge of achieving low average and worst-case latency for ultra-low latency (ULL) applications with small packets in Wi-Fi networks, particularly when all operation channels are occupied with long transmit opportunity (TXOP) data transmissions by other stations (STAs) within a Basic Service Set (BSS). The proposed methods and mechanisms involve integrating Aggregate-PSDU (A-PSDU) frame format with MPDU/PSDU preemption, dedicated Resource Units (RU), and PPDU/PSDU splitting. These improvements are expected to support clients with both small time-critical (TC) packets requiring ULL and large packets with high throughput requirements.

Low/deterministic latency and reliable communications are some of the main gaps in existing Wi-Fi radios (including 802.11ax) and there is an opportunity to address these problems in next generation Wi-Fi standards, 802.11be (Wi-Fi 7) or in Wi-Fi 8 with multiple link or other new capabilities. The mechanisms proposed in this disclosure will enable low latency small packet applications in 802.11 networks that are heavily loaded with other clients' high throughput transmissions to improve latency performance; while at the same time minimizing the performance impact to the high throughput traffic.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

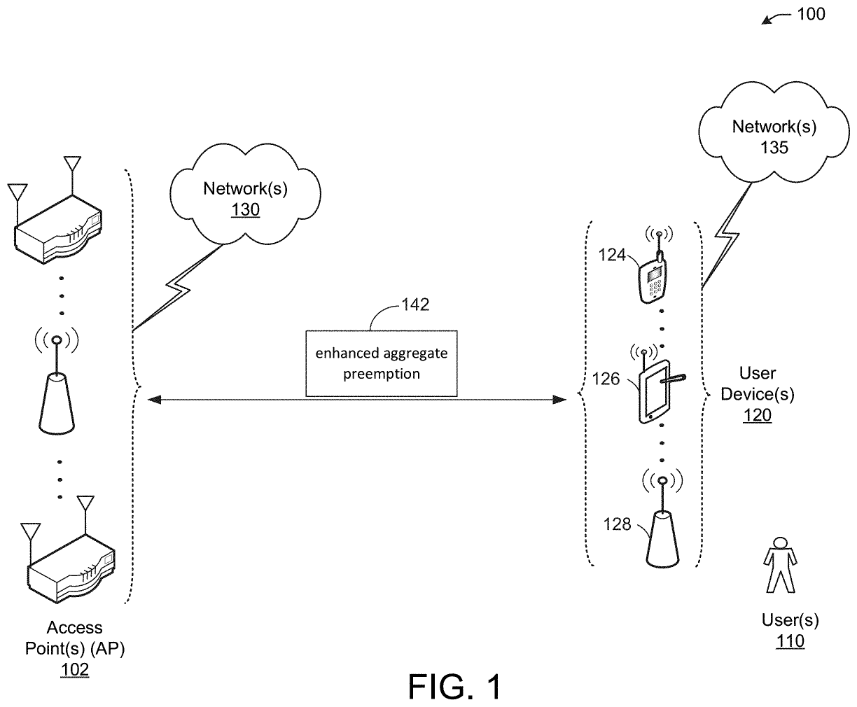

FIG. 1 is a network diagram illustrating an example network environment of enhanced aggregate preemption, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

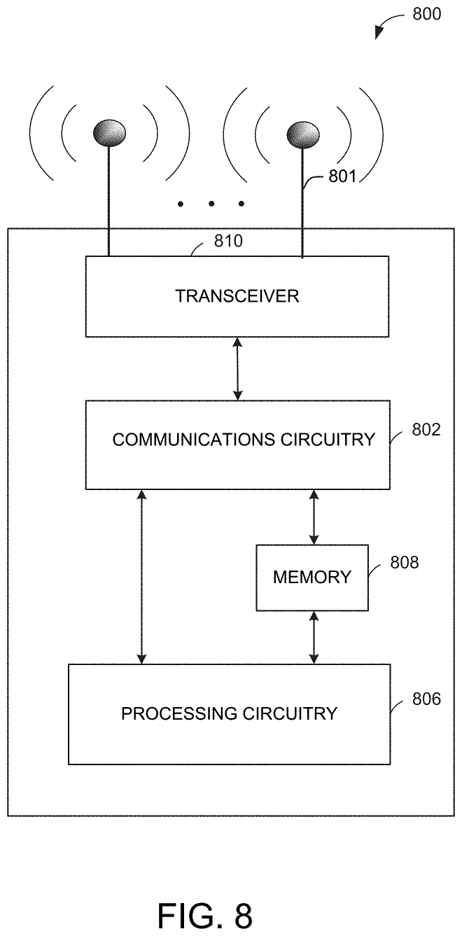

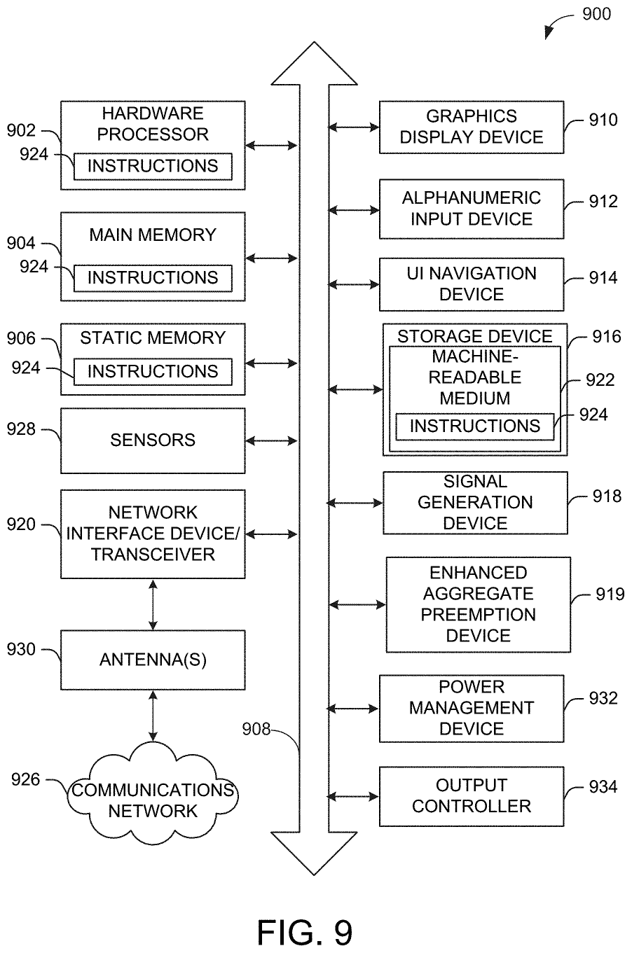

In some embodiments, the user devices 120 and the AP 102 may include one or more computer systems similar to that of the functional diagram of FIG. 8 and/or the example machine/system of FIG. 9.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement a enhanced aggregate preemption 142 with one or more user devices 120. It is understood that the above descriptions are for purposes of illustration and are not meant to be limiting.

It is understood that the above descriptions are for purposes of illustration and are not meant to be limiting.

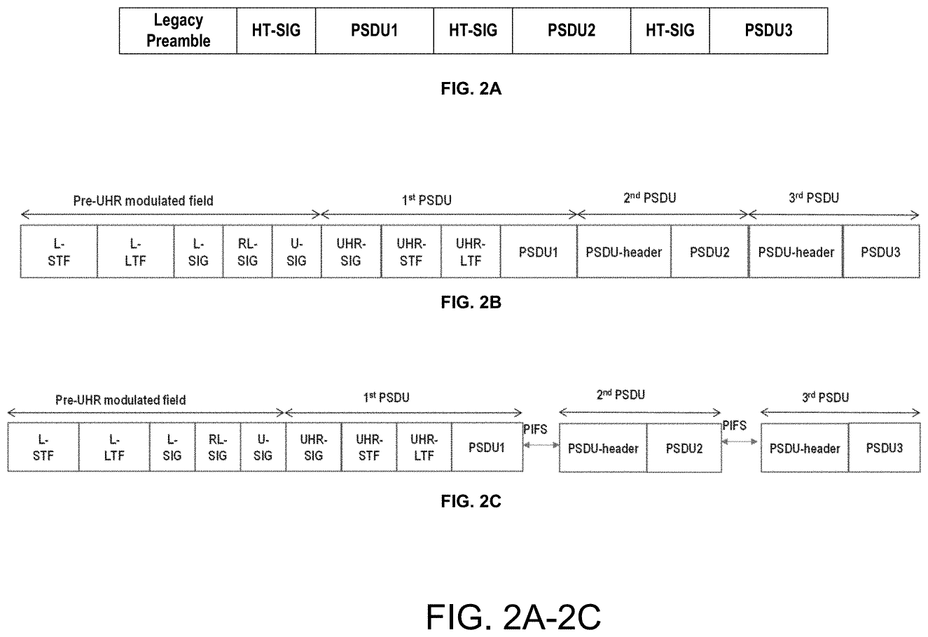

FIGS. 2A-2C depict illustrative schematic diagrams for an aggregate frame, in accordance with one or more example embodiments of the present disclosure.

The concept of A-PSDU was introduced alongside aggregate MPDU and aggregate MSDU during the development of the 802.11n standard. The primary idea involves aggregating multiple PSDUs within a single PPDU. There would be a High Throughput (HT)-SIG field before each PSDU to define the data rate and length of the PSDU, as well as to indicate whether it is the last PSDU or not. This is shown in FIG. 2A.

Referring to FIG. 2B, there is shown a frame format of an A-PSDU, where there is a pre-UHR modulated field and three PSDUs but without any time gaps between continuous PSDUs (e.g., PSDU 1, PSDU 2, or PSDU 3).

Referring to FIG. 2C, there is shown a frame format of an A-PSDU with fixed time duration (e.g., SIFS or PIFS) between each two continuous PSDUs (e.g., PSDU 1, PSDU2, or PSDU3).

The User Signal (U-SIG) will indicate whether an A-PSDU format is utilized and which format (with or without a fixed time duration between two continuous PSDUs) is to be used. The User High Rate Signal (UHR-SIG) may indicate the data rate, length of the subsequent PSDU, whether it is the last PSDU, whether the subsequent PSDU is for a different Receiver Address (RA), Association ID (AID) of the receiver, number of UHR-Long Training Field (LTF), the Guard Interval (GI)+LTF size, and whether beamforming is used in the following PSDU. The PSDU header may indicate the length of the subsequent PSDU and whether it is the last PSDU or whether there is a PSDU after the PSDU header by setting the PSDU length to be 0. It may also indicate whether the following PSDU is for a different RA; if so, an AID field is present. Furthermore, it may indicate whether a different Modulation and Coding Scheme (MCS) will be used for the subsequent PSDU; if so, an MCS field is present. It may also show whether beamforming is used in the following PSDU. The header may include a UHR-Short Training Field (STF) and UHR-LTF.

This disclosure describes how to utilize Medium Access Control Protocol Data Unit (MPDU)/PSDU preemption, dedicated Resource Units (RU), and PPDU/PSDU splitting to support Ultra-Low Latency (ULL) applications in various scenarios.

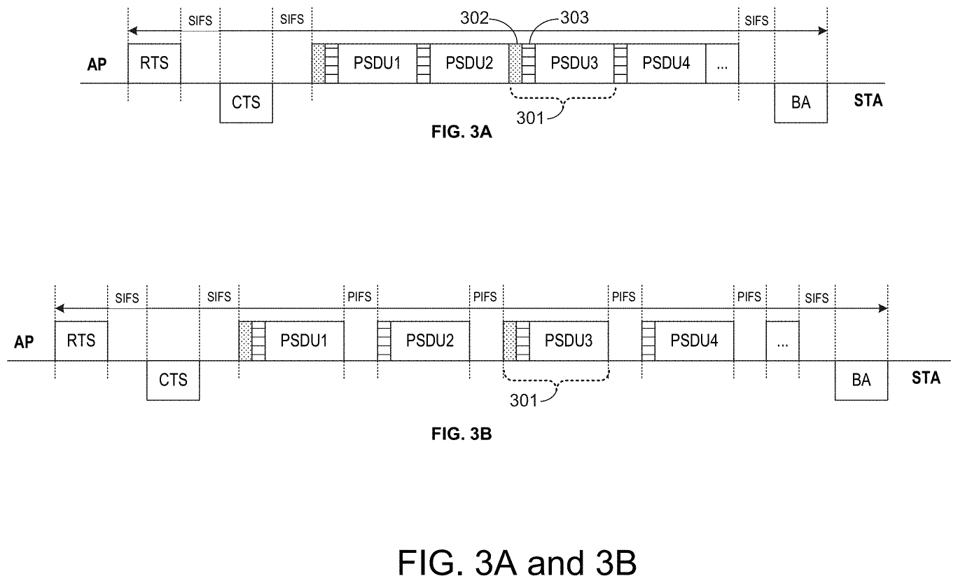

FIGS. 3A-3B, 4A-4B, 5A-5B, and 6A-6B depict illustrative schematic diagrams for enhanced aggregate preemption, in accordance with one or more example embodiments of the present disclosure.

In one or more embodiments, an enhanced aggregate preemption system may be used in a scenario involving a long downlink Transmit Opportunity (DL TXOP) transmission, where a downlink time-critical (DL TC) packet is intended for delivery to another different Station (STA).

As shown in FIGS. 3A and 3B, the long TXOP DL transmission is divided into multiple PSDU/PPDU transmission without or with fixed time such as, SIFS/PIFS, between the two continuous PSDU transmissions, there may be BA following each PSDU with SIFS time gap. The length of each DL PSDU/PPDU transmission will be designed based on the latency requirement of the ULL application. During the DL transmission, if the AP has a TC packet to be transmitted to an ULL STA, it can suspend the following PSDU/PPDU and insert the TC with pre UHR modulated field for the ULL STA as shown in FIGS. 3A and 3B.

To better understand this concept, consider a Wi-Fi network where an access point (AP) is communicating with various stations (STAs), including those with ULL applications. The AP schedules DL transmissions based on the latency requirements of the ULL applications.

FIGS. 3A and 3B illustrate the division of a long TXOP DL transmission into multiple PSDU/PPDU transmissions. In some cases, there may be a block acknowledgement (BA) following each PSDU with a SIFS time gap. During the DL transmission, if the AP has a time-critical (TC) packet to be transmitted to a ULL STA, it can suspend the following PSDU/PPDU transmission.

For example, consider an online gaming scenario where a player requires low-latency communication to ensure a smooth gaming experience. If the AP detects a TC packet, such as an urgent game update, it can pause the ongoing transmission and insert the TC packet into the communication stream. The inserted TC packet 301 is marked with a pre-Ultra High Rate (UHR) (Wi-Fi 8) modulated field 302 (as represented in dots inside element 302 in FIG. 3A and such representation is utilized in a same shape across all the figures), while the PSDU header is represented by a field 303 (as represented in horizontal lines inside element 303 in FIG. 3A and such representation is utilized in a same shape across all the figures). The addition of pre-Ultra High Rate modulated field and PSDU header is also used on other PSDUs and not only TC packets. For example, a pre-Ultra High Rate modulated field is used after a SIFS time between packets then followed by a PSDU header. However, only a PSDU header is used after a PIFS time between packets.

By using this technique, the AP can prioritize the transmission of urgent packets for ULL applications, improving the overall network performance and user experience in scenarios with stringent latency requirements.

In one or more embodiments, a enhanced aggregate preemption system may be used in a scenario for DL long TXOP transmission, while UL TC packets are to be transmitted from a different STA.

In one or more embodiments, a Wi-Fi network may comprise an access point (AP) is communicating with various stations (STAs), including those with ULL applications. To avoid confusion related to SIFS time gaps (16 microseconds), it is better to use PIFS time gaps (25 microseconds) to allow enough time for the switch between transmitting (TX) and receiving (RX) modes.

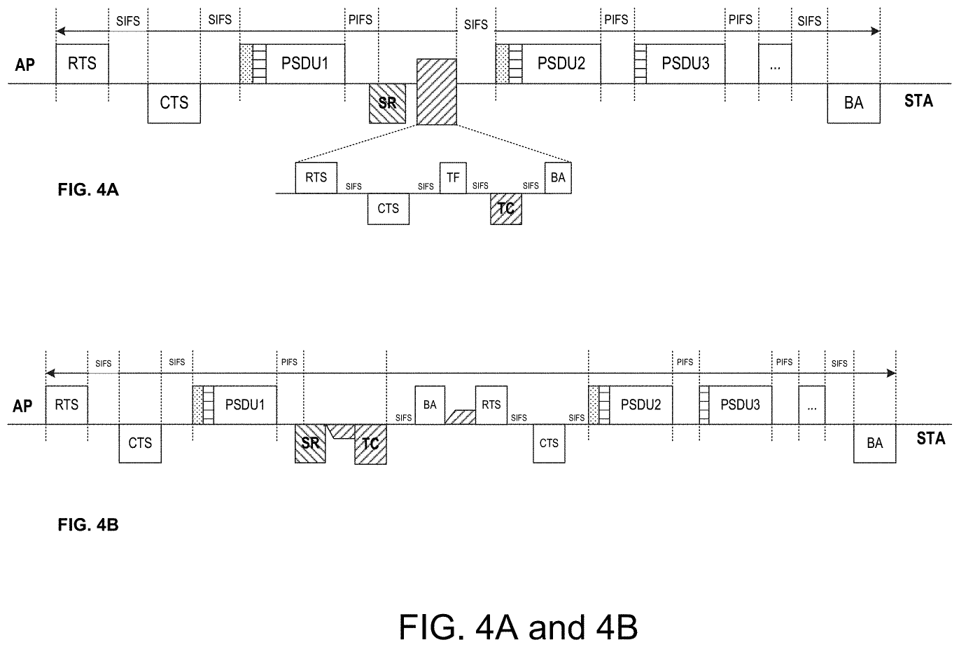

FIGS. 4A and 4B demonstrate the technique involving Request to Send/Clear to Send (RTS/CTS) frames to indicate the length of the TXOP, the specific STAs or applications allowed to access the medium during the TXOP, and the duration for ULL to perform channel contention and send a suspend request (SR) control frame.

A scenario may be where the AP is communicating with multiple devices, including ULL STAs like online gamers or IoT devices requiring low-latency communication. The SR control frame, which contains only the receiver address, allows multiple ULL STAs to send SR frames simultaneously with the same content. Upon receiving the SR frames, the AP will suspend the following PSDU/PPDU transmission and perform either of the following actions:

1) As shown in FIG. 4A, the AP sends a time-critical packet status report request frame (a trigger frame) to all or a group of ULL STAs that have registered with the ULL application request. Upon receiving the trigger, the ULL STA will provide feedback through a Null Data Packet (NDP) over the assigned Resource Unit (RU) or tone set if it has a time-critical (TC) packet to be sent. The AP then triggers the ULL STA to send the TC packet over the assigned RU and receive a Block Acknowledgement (BA). After completing the TC packet exchange, the AP resumes the next DL PSDU/PPDU transmission with a legacy preamble before the PSDU/PPDU, as shown in FIG. 4A.

2) As shown in FIG. 4B, the AP suspends the following transmission. ULL STAs with TC packets to be sent perform Enhanced Distributed Channel Access (EDCA) to access the medium and send the TC packet to the AP. After completing the TC/BA exchange between the AP and STA, the AP re-accesses the channel to start a new TXOP transmission or resumes the PSDU/PPDU transmission, as shown in FIG. 4B.

By employing this technique, the AP can manage and prioritize communication with multiple ULL devices effectively, ensuring that urgent packets for ULL applications are transmitted promptly and improving the overall network performance and user experience.

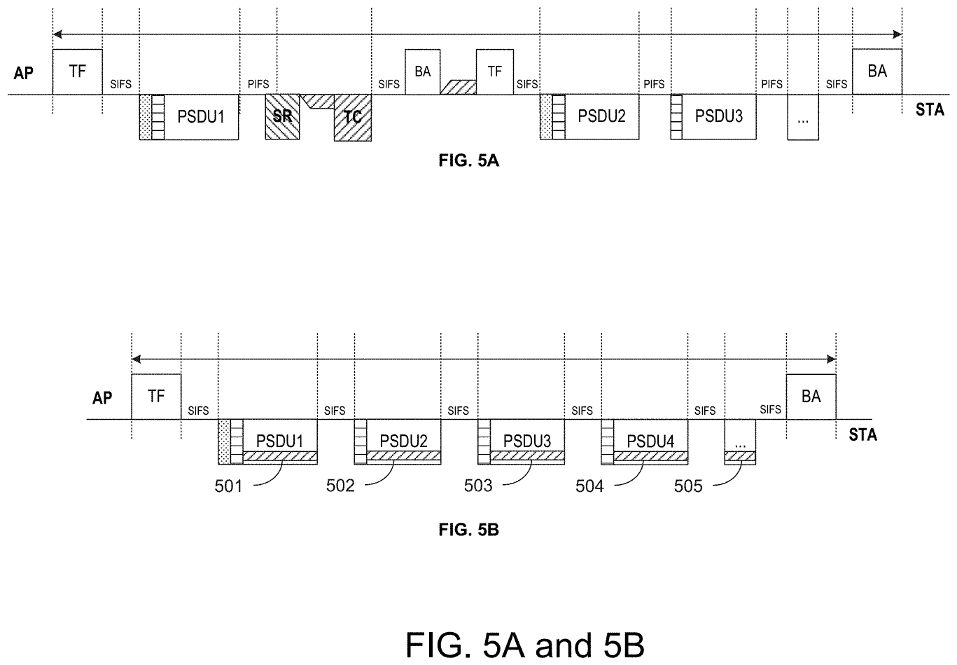

In one or more embodiments, an enhanced aggregate preemption system may be used in a scenario for an UL long TXOP transmission with UL TC packet from another STA. This scenario is illustrated in FIGS. 5A and 5B.

As shown in in these figures, the long TXOP UL transmission is divided into multiple PSDU/PPDU transmission with fixed time, such as SIFS/PIFS, between two continuous PSDU/PPDU transmission. There are two different ways to support UL TC transmission:

1) As depicted in FIG. 5A, the trigger frame (TF) may indicate the length of the TXOP, which STAs or applications are allowed to access the medium during the TXOP, and the duration that the ultra-low latency (ULL) STA can do channel contention and send a suspend request (SR) control frame after sensing that the channel is idle for SIFS+4 or SIFS+6 microseconds. Upon receiving the SR control frame, the UL STA transmitting the UL PSDU/PPDU will suspend the following PSDU/PPDU transmission. The ULL STA can perform Enhanced Distributed Channel Access (EDCA) and access the medium to transmit the TC packet. After the TC and Block Acknowledgment (BA) exchange between the access point (AP) and ULL STA, the AP may re-access the medium with a new TXOP to trigger the previous UL STA to send an UL packet, or send a trigger frame SIFS time after the BA to the ULL STA to resume the UL PSDU/PPDU transmission.

For example, in a Wi-Fi network, if a ULL STA needs to transmit an UL TC packet during an ongoing long TXOP UL transmission, the trigger frame may indicate the necessary information, and the ULL STA can send an SR control frame to suspend the ongoing transmission. After suspending the transmission, the ULL STA can access the medium and transmit the TC packet. Once the TC and BA exchange is complete, the AP can re-access the medium to resume the previous UL transmission.

2) As depicted in FIG. 5B, each PSDU/PPDU is transmitted using MU-OFDMA format, and one or more resource units (RUs) may be reserved for ULL STA for UL TC transmission (as shown in the reserved RUs 501, 502, 503, 504, and 505). During the UL transmission, if the ULL STAs are assigned with reserved RU for TC transmission, they will send dummy packets and insert TC packets in the MAC layer once they arrive in the transmission queue.

Utilizing reserved RUs plays a key role in maintaining ULL TC transmissions, especially in congested wireless environments. In a wireless network that uses Multi-User Orthogonal Frequency-Division Multiple Access (MU-OFDMA), the spectrum is divided into multiple sub-channels, each of which is called an RU. Multiple STAs can transmit and receive data simultaneously on different RUs, which enhances the network's overall efficiency. The concept of reserved RUs comes into play when there's a need to ensure that certain data—in this case, time-critical data from an ULL STA—gets transmitted without delay. For example, consider a network scenario with multiple STAs sending and receiving data. This situation might cause significant competition for access to RUs, potentially leading to delays. However, if one or more RUs are reserved specifically for ULL STAs, these STAs have a dedicated “lane” in which to send their data. This dedicated lane helps guarantee that their TC transmissions aren't delayed by other traffic, effectively maintaining ULL. During the UL transmission, the ULL STAs that are assigned with these reserved RUs will send a dummy packet initially. The purpose of this dummy packet can be seen as a placeholder in the transmission queue. As soon as the TC packet arrives in the transmission queue, it replaces the dummy packet. The process of inserting this TC packet happens at the MAC layer, thereby ensuring that the TC packets are given priority and are transmitted as soon as the medium is available, keeping the latency as low as possible. This approach can be particularly useful in scenarios where network congestion is high, and ensuring ULL for certain applications or data types is of paramount importance, such as in telemedicine or autonomous driving situations, where a delay in data transmission could have serious consequences.

3) Alternatively, after receiving the SR control frame, the AP can transmit a trigger frame to solicit TC packets from a group of ULL STAs, similar to the scenario depicted in FIG. 4A.

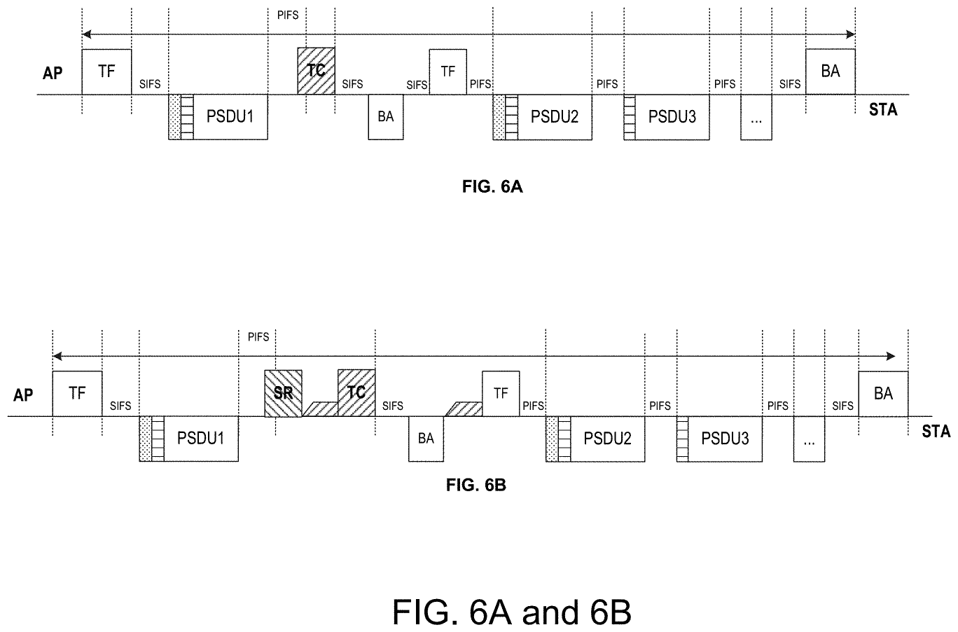

In one or more embodiments, an enhanced aggregate preemption system may be used in a scenario for a UL long TXOP transmission with DL TC packet from the AP to the ULL STA or UL TC packets from a ULL STA to the AP. This scenario is illustrated in FIGS. 6A and 6B.

As mentioned earlier, the long TXOP UL transmission is divided into multiple PSDU/PPDU transmission with fixed time intervals, such as PCF Interframe Space (PIFS), between two continuous PSDU transmissions. When the AP has a TC packet to send to the same or other STAs, or the UL ULL STA has a TC packet to send to the AP, the following are two illustrative ways to support the DL TC transmission:

1) ULL STA can send a suspend request (SR) control frame at a fixed time (e.g., SIFS+4 or SIFS+6 microseconds) after the end of the current PSDU/PPDU reception and sensing that the channel is idle for SIFS+4 or SIFS+6 microseconds. The AP can transmit the TC frame at a fixed time (e.g., SIFS+6 or SIFS+8 microseconds), which should be longer than the time used by the UL ULL STAs, after receiving the UL PSDU/PPDU and sensing that the channel is idle for SIFS+6 or SIFS+8 microseconds.

In a Wi-Fi network, if an AP has a TC packet to send to a ULL STA while the UL PSDU/PPDU transmission is ongoing, the ULL STA will send an SR control frame to the AP to suspend the ongoing transmission. The AP then transmits the TC frame, and the ULL STA suspends the following PSDU/PPDU transmission if it senses that the channel is busy PIFS time before starting the next PSDU/PPDU transmission. After the AP completes the TC/BA exchange with the ULL STA, the AP may re-access the medium with a new TXOP to trigger the previous UL STA to send an UL packet, or send a trigger frame to the previous UL STA to resume the UL PSDU/PPDU transmission SIFS after receiving the BA frame, as shown in FIG. 6A.

2) The AP or the ULL STAs can send an SR control frame at a fixed time (e.g., SIFS+4 or SIFS+6 microseconds) after the end of the current PSDU/PPDU reception and sensing that the channel is idle for SIFS+4 or SIFS+6 microseconds. Upon receiving the SR control frame, the UL STA transmitting the UL PSDU/PPDU will suspend the following PSDU/PPDU transmission. The AP and/or ULL STA can perform Enhanced Distributed Channel Access (EDCA) and access the medium to transmit the TC packet.

After the TC and BA exchange between the AP and ULL STA, the AP may re-access the medium with a new TXOP to trigger the previous UL STA to send an UL packet or send a trigger frame SIFS time after receiving the BA from the ULL STA to resume the UL PSDU/PPDU transmission, as shown in FIG. 6B.

It should be noted that the new Request to Send/Clear to Send (RTS/CTS) frames for DL long TXOP transmission and trigger frame for UL long TXOP transmission will indicate whether and when SR preemption is allowed and who has permission to preempt the TXOP transmission. The SR preemption also works in non-trigger frame-based UL transmission, and the indication of whether and when SR preemption is allowed and who has permission to preempt the TXOP transmission is integrated into the first UL PPDU/PSDU. STAs that have not received this information cannot perform SR preemption.

It is understood that the above descriptions are for purposes of illustration and are not meant to be limiting.

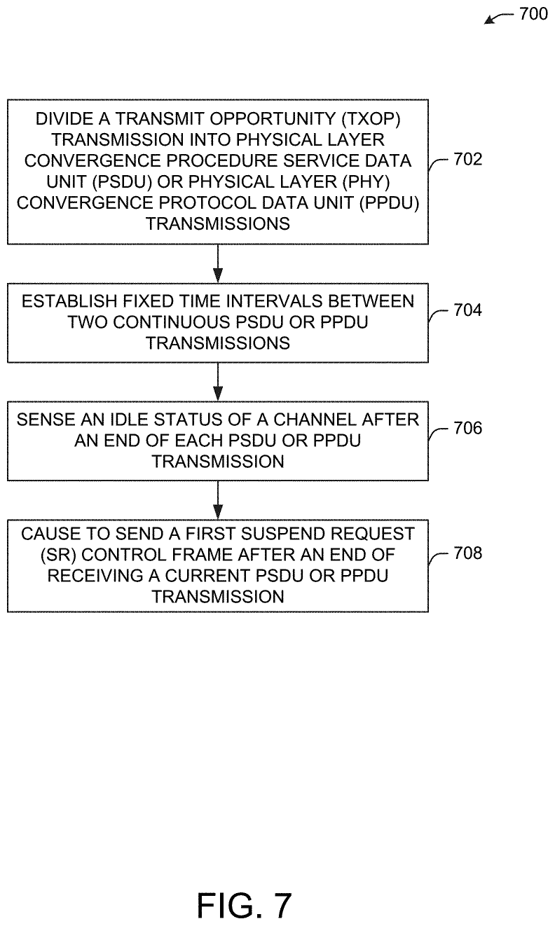

FIG. 7 illustrates a flow diagram of illustrative process 700 for a enhanced aggregate preemption system, in accordance with one or more example embodiments of the present disclosure.

At block 702, a device (e.g., the user device(s) 120 and/or the AP 102 of FIG. 1 and/or the enhanced aggregate preemption device 919 of FIG. 9) may divide a transmit opportunity (TXOP) transmission into physical layer convergence procedure service data unit (PSDU) or physical layer (PHY) convergence protocol data unit (PPDU) transmissions.

At block 704, the device may establish fixed time intervals between two continuous PSDU or PPDU transmissions.

At block 706, the device may sense an idle status of a channel after an end of each PSDU or PPDU transmission.

At block 708, the device may cause to send a first suspend request (SR) control frame after an end of receiving a current PSDU or PPDU transmission.

The device may have the ability to transmit a TC frame after receiving a UL PSDU or PPDU transmission and sensing that the channel is idle. Additionally, the device may have the ability to suspend an upcoming PSDU or PPDU transmission when it senses that the channel is busy prior to initiating the next PSDU or PPDU transmission. The device may also be designed to re-access the channel using a new TXOP, which could trigger a previous UL STA to send an UL packet. Further, the device may have the capability to send a trigger frame to the previous UL STA, enabling the resumption of an UL PSDU or PPDU transmission after a specific time interval following the receipt of a BA frame. The device may also be able to execute EDCA to gain access to the channel for the transmission of a TC frame. It might also have the ability to receive a second SR control frame, resulting in a UL STA that is transmitting an UL PSDU or PPDU to suspend the next PSDU or PPDU transmission. For SR preemption, the device may provide an indication of when SR preemption is allowed and when permission to preempt a TXOP transmission is granted. This indication could be incorporated into the first UL PSDU or PPDU transmission.

It is understood that the above descriptions are for purposes of illustration and are not meant to be limiting.

FIG. 8 shows a functional diagram of an exemplary communication station 800, in accordance with one or more example embodiments of the present disclosure. In one embodiment, FIG. 8 illustrates a functional block diagram of a communication station that may be suitable for use as an AP 102 (FIG. 1) or a user device 120 (FIG. 1) in accordance with some embodiments. The communication station 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in the above figures, diagrams, and flows.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), an enhanced aggregate preemption device 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 902 for generation and processing of the baseband signals and for controlling operations of the main memory 904, the storage device 916, and/or the enhanced aggregate preemption device 919. The baseband processor may be provided on a single radio card, a single chip, or an integrated circuit (IC).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The enhanced aggregate preemption device 919 may carry out or perform any of the operations and processes (e.g., process 700) described and shown above.

It is understood that the above are only a subset of what the enhanced aggregate preemption device 919 may be configured to perform and that other functions included throughout this disclosure may also be performed by the enhanced aggregate preemption device 919.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

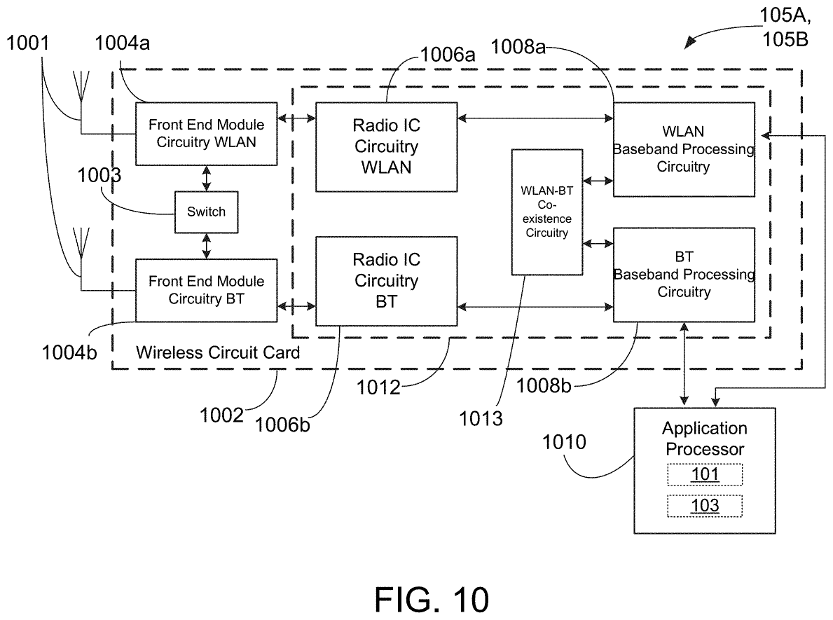

FIG. 10 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1004a-b, radio IC circuitry 1006a-b and baseband processing circuitry 1008a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1004a-b may include a WLAN or Wi-Fi FEM circuitry 1004a and a Bluetooth (BT) FEM circuitry 1004b. The WLAN FEM circuitry 1004a may include a receive signal path comprising circuitry configured to operate on WLAN RF signals received from one or more antennas 1001, to amplify the received signals and to provide the amplified versions of the received signals to the WLAN radio IC circuitry 1006a for further processing. The BT FEM circuitry 1004b may include a receive signal path which may include circuitry configured to operate on BT RF signals received from one or more antennas 1001, to amplify the received signals and to provide the amplified versions of the received signals to the BT radio IC circuitry 1006b for further processing. FEM circuitry 1004a may also include a transmit signal path which may include circuitry configured to amplify WLAN signals provided by the radio IC circuitry 1006a for wireless transmission by one or more of the antennas 1001. In addition, FEM circuitry 1004b may also include a transmit signal path which may include circuitry configured to amplify BT signals provided by the radio IC circuitry 1006b for wireless transmission by the one or more antennas. In the embodiment of FIG. 10, although FEM 1004a and FEM 1004b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1006a-b as shown may include WLAN radio IC circuitry 1006a and BT radio IC circuitry 1006b. The WLAN radio IC circuitry 1006a may include a receive signal path which may include circuitry to down-convert WLAN RF signals received from the FEM circuitry 1004a and provide baseband signals to WLAN baseband processing circuitry 1008a. BT radio IC circuitry 1006b may in turn include a receive signal path which may include circuitry to down-convert BT RF signals received from the FEM circuitry 1004b and provide baseband signals to BT baseband processing circuitry 1008b. WLAN radio IC circuitry 1006a may also include a transmit signal path which may include circuitry to up-convert WLAN baseband signals provided by the WLAN baseband processing circuitry 1008a and provide WLAN RF output signals to the FEM circuitry 1004a for subsequent wireless transmission by the one or more antennas 1001. BT radio IC circuitry 1006b may also include a transmit signal path which may include circuitry to up-convert BT baseband signals provided by the BT baseband processing circuitry 1008b and provide BT RF output signals to the FEM circuitry 1004b for subsequent wireless transmission by the one or more antennas 1001. In the embodiment of FIG. 10, although radio IC circuitries 1006a and 1006b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1008a-b may include a WLAN baseband processing circuitry 1008a and a BT baseband processing circuitry 1008b. The WLAN baseband processing circuitry 1008a may include a memory, such as, for example, a set of RAM arrays in a Fast Fourier Transform or Inverse Fast Fourier Transform block (not shown) of the WLAN baseband processing circuitry 1008a. Each of the WLAN baseband circuitry 1008a and the BT baseband circuitry 1008b may further include one or more processors and control logic to process the signals received from the corresponding WLAN or BT receive signal path of the radio IC circuitry 1006a-b, and to also generate corresponding WLAN or BT baseband signals for the transmit signal path of the radio IC circuitry 1006a-b. Each of the baseband processing circuitries 1008a and 1008b may further include physical layer (PHY) and medium access control layer (MAC) circuitry, and may further interface with a device for generation and processing of the baseband signals and for controlling operations of the radio IC circuitry 1006a-b.

Referring still to FIG. 10, according to the shown embodiment, WLAN-BT coexistence circuitry 1013 may include logic providing an interface between the WLAN baseband circuitry 1008a and the BT baseband circuitry 1008b to enable use cases requiring WLAN and BT coexistence. In addition, a switch 1003 may be provided between the WLAN FEM circuitry 1004a and the BT FEM circuitry 1004b to allow switching between the WLAN and BT radios according to application needs. In addition, although the antennas 1001 are depicted as being respectively connected to the WLAN FEM circuitry 1004a and the BT FEM circuitry 1004b, embodiments include within their scope the sharing of one or more antennas as between the WLAN and BT FEMs, or the provision of more than one antenna connected to each of FEM 1004a or 1004b.

In some embodiments, the front-end module circuitry 1004a-b, the radio IC circuitry 1006a-b, and baseband processing circuitry 1008a-b may be provided on a single radio card, such as wireless radio card 1002. In some other embodiments, the one or more antennas 1001, the FEM circuitry 1004a-b and the radio IC circuitry 1006a-b may be provided on a single radio card. In some other embodiments, the radio IC circuitry 1006a-b and the baseband processing circuitry 1008a-b may be provided on a single chip or integrated circuit (IC), such as IC 1012.

In some embodiments, the wireless radio card 1002 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1008b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

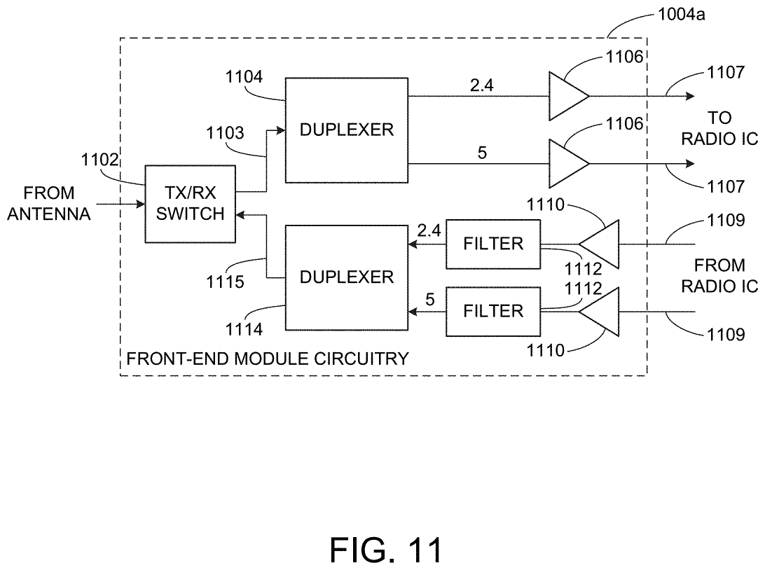

FIG. 11 illustrates WLAN FEM circuitry 1004a in accordance with some embodiments. Although the example of FIG. 11 is described in conjunction with the WLAN FEM circuitry 1004a, the example of FIG. 11 may be described in conjunction with the example BT FEM circuitry 1004b (FIG. 10), although other circuitry configurations may also be suitable.

In some embodiments, the FEM circuitry 1004a may include a TX/RX switch 1102 to switch between transmit mode and receive mode operation. The FEM circuitry 1004a may include a receive signal path and a transmit signal path. The receive signal path of the FEM circuitry 1004a may include a low-noise amplifier (LNA) 1106 to amplify received RF signals 1103 and provide the amplified received RF signals 1107 as an output (e.g., to the radio IC circuitry 1006a-b (FIG. 10)). The transmit signal path of the circuitry 1004a may include a power amplifier (PA) to amplify input RF signals 1109 (e.g., provided by the radio IC circuitry 1006a-b), and one or more filters 1112, such as band-pass filters (BPFs), low-pass filters (LPFs) or other types of filters, to generate RF signals 1115 for subsequent transmission (e.g., by one or more of the antennas 1001 (FIG. 10)) via an example duplexer 1114.

In some dual-mode embodiments for Wi-Fi communication, the FEM circuitry 1004a may be configured to operate in either the 2.4 GHz frequency spectrum or the 5 GHz frequency spectrum. In these embodiments, the receive signal path of the FEM circuitry 1004a may include a receive signal path duplexer 1104 to separate the signals from each spectrum as well as provide a separate LNA 1106 for each spectrum as shown. In these embodiments, the transmit signal path of the FEM circuitry 1004a may also include a power amplifier 1110 and a filter 1112, such as a BPF, an LPF or another type of filter for each frequency spectrum and a transmit signal path duplexer 1104 to provide the signals of one of the different spectrums onto a single transmit path for subsequent transmission by the one or more of the antennas 1001 (FIG. 10). In some embodiments, BT communications may utilize the 2.4 GHz signal paths and may utilize the same FEM circuitry 1004a as the one used for WLAN communications.

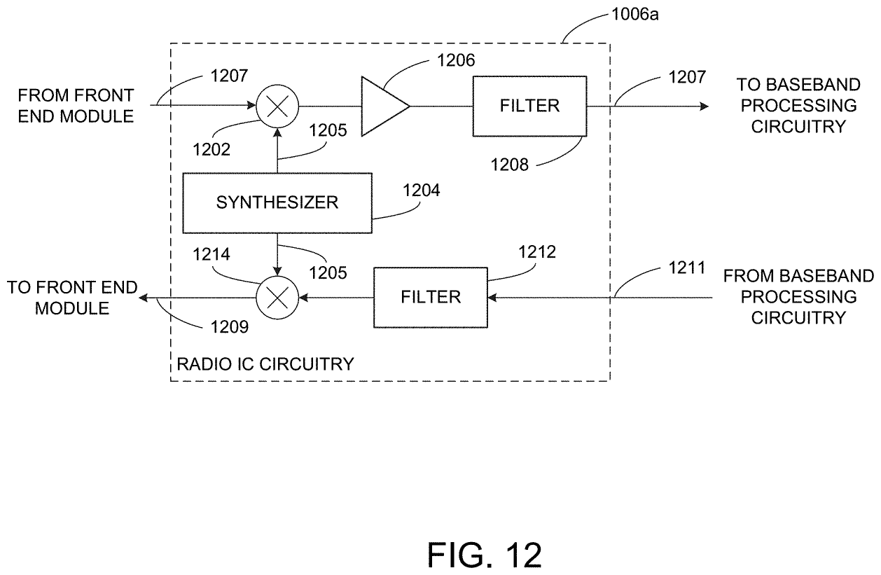

FIG. 12 illustrates radio IC circuitry 1006a in accordance with some embodiments. The radio IC circuitry 1006a is one example of circuitry that may be suitable for use as the WLAN or BT radio IC circuitry 1006a/1006b (FIG. 10), although other circuitry configurations may also be suitable. Alternatively, the example of FIG. 12 may be described in conjunction with the example BT radio IC circuitry 1006b.

In some embodiments, the radio IC circuitry 1006a may include a receive signal path and a transmit signal path. The receive signal path of the radio IC circuitry 1006a may include at least mixer circuitry 1202, such as, for example, down-conversion mixer circuitry, amplifier circuitry 1206 and filter circuitry 1208. The transmit signal path of the radio IC circuitry 1006a may include at least filter circuitry 1212 and mixer circuitry 1214, such as, for example, up-conversion mixer circuitry. Radio IC circuitry 1006a may also include synthesizer circuitry 1204 for synthesizing a frequency 1205 for use by the mixer circuitry 1202 and the mixer circuitry 1214. The mixer circuitry 1202 and/or 1214 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 12 illustrates only a simplified version of a radio IC circuitry, and may include, although not shown, embodiments where each of the depicted circuitries may include more than one component. For instance, mixer circuitry 1214 may each include one or more mixers, and filter circuitries 1208 and/or 1212 may each include one or more filters, such as one or more BPFs and/or LPFs according to application needs. For example, when mixer circuitries are of the direct-conversion type, they may each include two or more mixers.

In some embodiments, mixer circuitry 1202 may be configured to down-convert RF signals 1107 received from the FEM circuitry 1004a-b (FIG. 10) based on the synthesized frequency 1205 provided by synthesizer circuitry 1204. The amplifier circuitry 1206 may be configured to amplify the down-converted signals and the filter circuitry 1208 may include an LPF configured to remove unwanted signals from the down-converted signals to generate output baseband signals 1207. Output baseband signals 1207 may be provided to the baseband processing circuitry 1008a-b (FIG. 10) for further processing. In some embodiments, the output baseband signals 1207 may be zero-frequency baseband signals, although this is not a requirement. In some embodiments, mixer circuitry 1202 may comprise passive mixers, although the scope of the embodiments is not limited in this respect.

In some embodiments, the mixer circuitry 1214 may be configured to up-convert input baseband signals 1211 based on the synthesized frequency 1205 provided by the synthesizer circuitry 1204 to generate RF output signals 1109 for the FEM circuitry 1004a-b. The baseband signals 1211 may be provided by the baseband processing circuitry 1008a-b and may be filtered by filter circuitry 1212. The filter circuitry 1212 may include an LPF or a BPF, although the scope of the embodiments is not limited in this respect.

In some embodiments, the mixer circuitry 1202 and the mixer circuitry 1214 may each include two or more mixers and may be arranged for quadrature down-conversion and/or up-conversion respectively with the help of synthesizer 1204. In some embodiments, the mixer circuitry 1202 and the mixer circuitry 1214 may each include two or more mixers each configured for image rejection (e.g., Hartley image rejection). In some embodiments, the mixer circuitry 1202 and the mixer circuitry 1214 may be arranged for direct down-conversion and/or direct up-conversion, respectively. In some embodiments, the mixer circuitry 1202 and the mixer circuitry 1214 may be configured for super-heterodyne operation, although this is not a requirement.

Mixer circuitry 1202 may comprise, according to one embodiment: quadrature passive mixers (e.g., for the in-phase (I) and quadrature phase (Q) paths). In such an embodiment, RF input signal 1107 from FIG. 12 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1205 of synthesizer 1204 (FIG. 12). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1107 (FIG. 11) may comprise a balanced signal, although the scope of the embodiments is not limited in this respect. The I and Q baseband output signals may be provided to low-noise amplifier, such as amplifier circuitry 1206 (FIG. 12) or to filter circuitry 1208 (FIG. 12).

In some embodiments, the output baseband signals 1207 and the input baseband signals 1211 may be analog baseband signals, although the scope of the embodiments is not limited in this respect. In some alternate embodiments, the output baseband signals 1207 and the input baseband signals 1211 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1204 may be a fractional-N synthesizer or a fractional N/N+1 synthesizer, although the scope of the embodiments is not limited in this respect as other types of frequency synthesizers may be suitable. For example, synthesizer circuitry 1204 may be a delta-sigma synthesizer, a frequency multiplier, or a synthesizer comprising a phase-locked loop with a frequency divider. According to some embodiments, the synthesizer circuitry 1204 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1204 may be provided by a voltage controlled oscillator (VCO), although that is not a requirement. A divider control input may further be provided by either the baseband processing circuitry 1008a-b (FIG. 10) depending on the desired output frequency 1205. In some embodiments, a divider control input (e.g., N) may be determined from a look-up table (e.g., within a Wi-Fi card) based on a channel number and a channel center frequency as determined or indicated by the example application processor 1010. The application processor 1010 may include, or otherwise be connected to, one of the example secure signal converter 101 or the example received signal converter 103 (e.g., depending on which device the example radio architecture is implemented in).

In some embodiments, synthesizer circuitry 1204 may be configured to generate a carrier frequency as the output frequency 1205, while in other embodiments, the output frequency 1205 may be a fraction of the carrier frequency (e.g., one-half the carrier frequency, one-third the carrier frequency). In some embodiments, the output frequency 1205 may be a LO frequency (fLO).

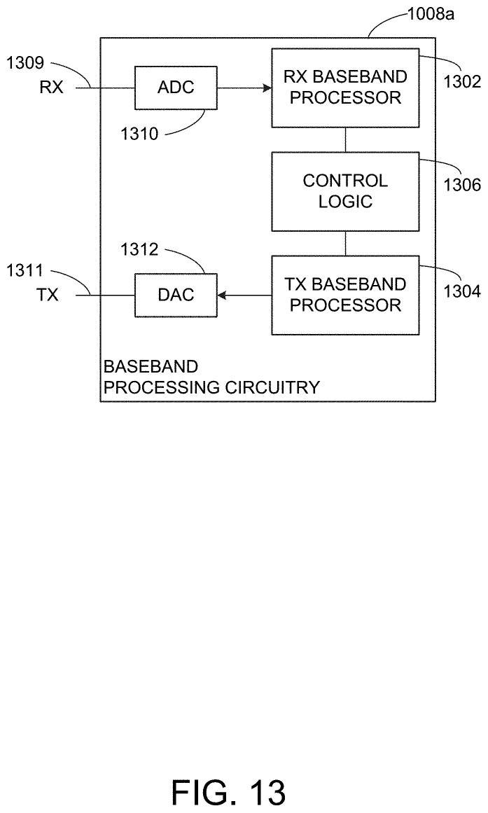

FIG. 13 illustrates a functional block diagram of baseband processing circuitry 1008a in accordance with some embodiments. The baseband processing circuitry 1008a is one example of circuitry that may be suitable for use as the baseband processing circuitry 1008a (FIG. 10), although other circuitry configurations may also be suitable. Alternatively, the example of FIG. 12 may be used to implement the example BT baseband processing circuitry 1008b of FIG. 10.

The baseband processing circuitry 1008a may include a receive baseband processor (RX BBP) 1302 for processing receive baseband signals 1209 provided by the radio IC circuitry 1006a-b (FIG. 10) and a transmit baseband processor (TX BBP) 1304 for generating transmit baseband signals 1211 for the radio IC circuitry 1006a-b. The baseband processing circuitry 1008a may also include control logic 1306 for coordinating the operations of the baseband processing circuitry 1008a.

In some embodiments (e.g., when analog baseband signals are exchanged between the baseband processing circuitry 1008a-b and the radio IC circuitry 1006a-b), the baseband processing circuitry 1008a may include ADC 1310 to convert analog baseband signals 1309 received from the radio IC circuitry 1006a-b to digital baseband signals for processing by the RX BBP 1302. In these embodiments, the baseband processing circuitry 1008a may also include DAC 1312 to convert digital baseband signals from the TX BBP 1304 to analog baseband signals 1311.

In some embodiments that communicate OFDM signals or OFDMA signals, such as through baseband processor 1008a, the transmit baseband processor 1304 may be configured to generate OFDM or OFDMA signals as appropriate for transmission by performing an inverse fast Fourier transform (IFFT). The receive baseband processor 1302 may be configured to process received OFDM signals or OFDMA signals by performing an FFT. In some embodiments, the receive baseband processor 1302 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 10, in some embodiments, the antennas 1001 (FIG. 10) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1001 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: divide a transmit opportunity (TXOP) transmission into physical layer convergence procedure service data unit (PSDU) or physical layer (PHY) convergence protocol data unit (PPDU) transmissions; establish fixed time intervals between two continuous PSDU or PPDU transmissions; sense an idle status of a channel after an end of each PSDU or PPDU transmission; and cause to send a first suspend request (SR) control frame after an end of receiving a current PSDU or PPDU transmission.

Example 2 may include the device of example 1 and/or some other example herein, wherein the processing circuitry may be further configured to transmit a time critical (TC) frame after receiving a uplink (UL) PSDU or PPDU transmission and sensing an idle status of the channel.

Example 3 may include the device of example 1 and/or some other example herein, wherein the processing circuitry may be further configured to suspend a following PSDU or PPDU transmission upon sensing that the channel may be busy before initiating a next PSDU or PPDU transmission.

Example 4 may include the device of example 1 and/or some other example herein, wherein the processing circuitry may be further configured to re-access the channel with a new TXOP to trigger a previous uplink (UL) station device (STA) to send an uplink packet.

Example 5 may include the device of example 4 and/or some other example herein, wherein the processing circuitry may be further configured to send a trigger frame to the previous UL STA to resume a UL PSDU or PPDU transmission after a specific time interval following a reception of a block acknowledgment (BA) frame.

Example 6 may include the device of example 1 and/or some other example herein, wherein the processing circuitry may be further configured to execute enhanced distributed channel access (EDCA) to access the channel to transmit a TC frame.

Example 7 may include the device of example 1 and/or some other example herein, wherein the processing circuitry may be further configured to receive a second SR control frame causing a UL STA transmitting a UL PSDU or PPDU to suspend a following PSDU or PPDU transmission.

Example 8 may include the device of example 1 and/or some other example herein, wherein the processing circuitry may be further configured to provide an indication when an SR preemption may be allowed and a permission to preempt a TXOP transmission.

Example 9 may include the device of example 8 and/or some other example herein, wherein the indication may be included in a first UL PSDU or PPDU transmission.

Example 10 may include a non-transitory computer-readable medium storing computer-executable instructions which when executed by one or more processors result in performing operations comprising: dividing a transmit opportunity (TXOP) transmission into physical layer convergence procedure service data unit (PSDU) or physical layer (PHY) convergence protocol data unit (PPDU) transmissions; establishing fixed time intervals between two continuous PSDU or PPDU transmissions; sensing an idle status of a channel after an end of each PSDU or PPDU transmission; and causing to send a first suspend request (SR) control frame after an end of receiving a current PSDU or PPDU transmission.

Example 11 may include the non-transitory computer-readable medium of example 10 and/or some other example herein, wherein the operations further comprise transmitting a time critical (TC) frame after receiving an uplink (UL) PSDU or PPDU transmission and sensing an idle status of the channel.

Example 12 may include the non-transitory computer-readable medium of example 10 and/or some other example herein, wherein the operations further comprise suspending a following PSDU or PPDU transmission upon sensing that the channel may be busy before initiating a next PSDU or PPDU transmission.

Example 13 may include the non-transitory computer-readable medium of example 10 and/or some other example herein, wherein the operations further comprise re-accessing the channel with a new TXOP to trigger a previous uplink (UL) station device (STA) to send an uplink packet.

Example 14 may include the non-transitory computer-readable medium of example 13 and/or some other example herein, wherein the operations further comprise sending a trigger frame to the previous UL STA to resume a UL PSDU or PPDU transmission after a specific time interval following a reception of a block acknowledgment (BA) frame.

Example 15 may include the non-transitory computer-readable medium of example 10 and/or some other example herein, wherein the operations further comprise executing enhanced distributed channel access (EDCA) to access the channel to transmit a TC frame.

Example 16 may include the non-transitory computer-readable medium of example 10 and/or some other example herein, wherein the operations further comprise receiving a second SR control frame causing a UL STA transmitting a UL PSDU or PPDU to suspend a following PSDU or PPDU transmission.

Example 17 may include the non-transitory computer-readable medium of example 10 and/or some other example herein, wherein the operations further comprise providing an indication when an SR preemption may be allowed and a permission to preempt a TXOP transmission.

Example 18 may include the non-transitory computer-readable medium of example 8 and/or some other example herein, wherein the indication may be included in a first UL PSDU or PPDU transmission.

Example 19 may include a method comprising: dividing a transmit opportunity (TXOP) transmission into physical layer convergence procedure service data unit (PSDU) or physical layer (PHY) convergence protocol data unit (PPDU) transmissions; establishing fixed time intervals between two continuous PSDU or PPDU transmissions; sensing an idle status of a channel after an end of each PSDU or PPDU transmission; and causing to send a first suspend request (SR) control frame after an end of receiving a current PSDU or PPDU transmission.

Example 20 may include the method of example 19 and/or some other example herein, further comprising transmitting a time critical (TC) frame after receiving a uplink (UL) PSDU or PPDU transmission and sensing an idle status of the channel.

Example 21 may include the method of example 19 and/or some other example herein, further comprising suspending a following PSDU or PPDU transmission upon sensing that the channel may be busy before initiating a next PSDU or PPDU transmission.

Example 22 may include the method of example 19 and/or some other example herein, further comprising re-accessing the channel with a new TXOP to trigger a previous uplink (UL) station device (STA) to send an uplink packet.

Example 23 may include the method of example 22 and/or some other example herein, further comprising sending a trigger frame to the previous UL STA to resume a UL PSDU or PPDU transmission after a specific time interval following a reception of a block acknowledgment (BA) frame.

Example 24 may include the method of example 19 and/or some other example herein, further comprising executing enhanced distributed channel access (EDCA) to access the channel to transmit a TC frame.

Example 25 may include the method of example 19 and/or some other example herein, further comprising receiving a second SR control frame causing a UL STA transmitting a UL PSDU or PPDU to suspend a following PSDU or PPDU transmission.

Example 26 may include the method of example 19 and/or some other example herein, further comprising providing an indication when an SR preemption may be allowed and a permission to preempt a TXOP transmission.

Example 27 may include the method of example 26 and/or some other example herein, wherein the indication may be included in a first UL PSDU or PPDU transmission.

Example 28 may include an apparatus comprising means for: dividing a transmit opportunity (TXOP) transmission into physical layer convergence procedure service data unit (PSDU) or physical layer (PHY) convergence protocol data unit (PPDU) transmissions; establishing fixed time intervals between two continuous PSDU or PPDU transmissions; sensing an idle status of a channel after an end of each PSDU or PPDU transmission; and causing to send a first suspend request (SR) control frame after an end of receiving a current PSDU or PPDU transmission.

Example 29 may include the apparatus of example 28 and/or some other example herein, further comprising transmitting a time critical (TC) frame after receiving a uplink (UL) PSDU or PPDU transmission and sensing an idle status of the channel.

Example 30 may include the apparatus of example 28 and/or some other example herein, further comprising suspending a following PSDU or PPDU transmission upon sensing that the channel may be busy before initiating a next PSDU or PPDU transmission.

Example 31 may include the apparatus of example 28 and/or some other example herein, further comprising re-accessing the channel with a new TXOP to trigger a previous uplink (UL) station device (STA) to send an uplink packet.

Example 32 may include the apparatus of example 31 and/or some other example herein, further comprising sending a trigger frame to the previous UL STA to resume a UL PSDU or PPDU transmission after a specific time interval following a reception of a block acknowledgment (BA) frame.

Example 33 may include the apparatus of example 28 and/or some other example herein, further comprising executing enhanced distributed channel access (EDCA) to access the channel to transmit a TC frame.

Example 34 may include the apparatus of example 28 and/or some other example herein, further comprising receiving a second SR control frame causing a UL STA transmitting a UL PSDU or PPDU to suspend a following PSDU or PPDU transmission.

Example 35 may include the apparatus of example 28 and/or some other example herein, further comprising providing an indication when an SR preemption may be allowed and a permission to preempt a TXOP transmission.

Example 36 may include the apparatus of example 35 and/or some other example herein, wherein the indication may be included in a first UL PSDU or PPDU transmission.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
divide a transmit opportunity (TXOP) transmission into physical layer convergence procedure service data unit (PSDU) or physical layer (PHY) convergence protocol data unit (PPDU) transmissions;
establish fixed time intervals between two continuous PSDU or PPDU transmissions;
sense an idle status of a channel after an end of each PSDU or PPDU transmission; and
cause to send a first suspend request (SR) control frame after an end of receiving a current PSDU or PPDU transmission.

2. The device of claim 1, wherein the processing circuitry is further configured to transmit a time critical (TC) frame after receiving a uplink (UL) PSDU or PPDU transmission and sensing an idle status of the channel.

3. The device of claim 1, wherein the processing circuitry is further configured to suspend a following PSDU or PPDU transmission upon sensing that the channel is busy before initiating a next PSDU or PPDU transmission.

4. The device of claim 1, wherein the processing circuitry is further configured to re-access the channel with a new TXOP to trigger a previous uplink (UL) station device (STA) to send an uplink packet.

5. The device of claim 4, wherein the processing circuitry is further configured to send a trigger frame to the previous UL STA to resume a UL PSDU or PPDU transmission after a specific time interval following a reception of a block acknowledgment (BA) frame.

6. The device of claim 1, wherein the processing circuitry is further configured to execute enhanced distributed channel access (EDCA) to access the channel to transmit a TC frame.

7. The device of claim 1, wherein the processing circuitry is further configured to receive a second SR control frame causing a UL STA transmitting a UL PSDU or PPDU to suspend a following PSDU or PPDU transmission.

8. The device of claim 1, wherein the processing circuitry is further configured to provide an indication when an SR preemption is allowed and a permission to preempt a TXOP transmission.

9. The device of claim 8, wherein the indication is included in a first UL PSDU or PPDU transmission.

10. A non-transitory computer-readable medium storing computer-executable instructions which when executed by one or more processors result in performing operations comprising:
dividing a transmit opportunity (TXOP) transmission into physical layer convergence procedure service data unit (PSDU) or physical layer (PHY) convergence protocol data unit (PPDU) transmissions;
establishing fixed time intervals between two continuous PSDU or PPDU transmissions;
sensing an idle status of a channel after an end of each PSDU or PPDU transmission; and
causing to send a first suspend request (SR) control frame after an end of receiving a current PSDU or PPDU transmission.

11. The non-transitory computer-readable medium of claim 10, wherein the operations further comprise transmitting a time critical (TC) frame after receiving a uplink (UL) PSDU or PPDU transmission and sensing an idle status of the channel.

12. The non-transitory computer-readable medium of claim 10, wherein the operations further comprise suspending a following PSDU or PPDU transmission upon sensing that the channel is busy before initiating a next PSDU or PPDU transmission.

13. The non-transitory computer-readable medium of claim 10, wherein the operations further comprise re-accessing the channel with a new TXOP to trigger a previous uplink (UL) station device (STA) to send an uplink packet.

14. The non-transitory computer-readable medium of claim 13, wherein the operations further comprise sending a trigger frame to the previous UL STA to resume a UL PSDU or PPDU transmission after a specific time interval following a reception of a block acknowledgment (BA) frame.

15. The non-transitory computer-readable medium of claim 10, wherein the operations further comprise executing enhanced distributed channel access (EDCA) to access the channel to transmit a TC frame.

16. The non-transitory computer-readable medium of claim 10, wherein the operations further comprise receiving a second SR control frame causing a UL STA transmitting a UL PSDU or PPDU to suspend a following PSDU or PPDU transmission.

17. The non-transitory computer-readable medium of claim 10, wherein the operations further comprise providing an indication when an SR preemption is allowed and a permission to preempt a TXOP transmission.

18. The non-transitory computer-readable medium of claim 8, wherein the indication is included in a first UL PSDU or PPDU transmission.

19. A method comprising:
dividing a transmit opportunity (TXOP) transmission into physical layer convergence procedure service data unit (PSDU) or physical layer (PHY) convergence protocol data unit (PPDU) transmissions;
establishing fixed time intervals between two continuous PSDU or PPDU transmissions;
sensing an idle status of a channel after an end of each PSDU or PPDU transmission; and
causing to send a first suspend request (SR) control frame after an end of receiving a current PSDU or PPDU transmission.

20. The method of claim 19, further comprising transmitting a time critical (TC) frame after receiving a uplink (UL) PSDU or PPDU transmission and sensing an idle status of the channel.
